(19) United States
(12) Patent Application Publication
(10) Pub. No.: US 2025/0340418 A1
(43) Pub. Date: Nov. 6, 2025

(54) JACK PAD WITH SPRING CLIP ATTACHMENT TO A JACK FOOT FOR VEHICLE JACKS

(71) Applicant: 4 MAVERICKS LLC, Castle Rock, CO (US)

(72) Inventors: Daniel L. Decker, JR., Castle Rock, CO (US); Jerad M. Burkhart, Castle Rock, CO (US); Aaron Goers, Castle Rock, CO (US)

(21) Appl. No.: 18/652,749

(22) Filed: May 1, 2024

(51) Int. Cl. B66F 13/00

(52) U.S. Cl. CPC B66F 13/00

(57) ABSTRACT

A jack pad with spring clip attachment to a jack foot is described for vehicle jacks. In one example, a jack pad has a base having a bottom surface configured to rest on the ground and a top surface having a crown. The crown is being configured to receive a jack foot. A plurality of spring clips, each having a first end attached to the base and a second end configured to press against the jack foot are over the jack foot when the jack foot is received in the crown.

### FIELD

The present description relates to vehicle jacks that include a jack foot, and in particular to a jack pad for the jack foot.

### BACKGROUND

Leveling jacks are used in RVs (Recreational Vehicles), such as motor homes and travel trailers, after the RV is parked, to level the floor of the RV. The leveling jacks are attached to the underside or sides of the RV, such as to the frame of the RV. A trailer may have one or more leveling jacks at or near the towing hitch in addition to at the sides or rear. The ground at many sites is uneven or sloped, so leveling jacks raise one or more corners or sides of the RV to compensate. A level floor when parked may allow for better sleeping, more efficient operation of appliances and a better overall experience. For livestock and cargo trailers, leveling jacks reduce stress on livestock or cargo when the trailer is parked. A leveling jack has a jack foot connected to a piston or arm that extends the jack foot down from the RV toward the ground to lift the RV away from the ground at the point at which the jack attaches to the RV.

Stabilizing jacks address the movement of an RV through its suspension system, such as the springs at each wheel, by holding an RV against moving up or down when people, livestock, or things are moving inside the RV. These jacks typically also have a foot to contact the ground below and a mechanical, electrical, or hydraulic system to deploy the foot against the ground.

The jack foot is usually a round galvanized steel disk that presses against the ground and bears the weight of a part of the RV when the leveling jack or stabilizing jack is deployed. Jack feet are also made in square, rectangular and other shapes. Jack pads are placed between a jack foot and the ground for several different reasons. In some cases, a jack pad presents a larger surface area against the ground to prevent the jack foot from sinking into soft ground. In some cases, a campsite operator may require a jack pad to distribute the force of the jack foot over a wider area to protect a campsite from damage by the jack foot. Some jack pads are placed on the ground below a jack foot and the jack lowers the foot onto the jack pad. Some jack pads attach to a jack foot when in use but are then removed and stored when the RV is in transit. Some jack pads attach to the jack foot and are not normally removed.

### BRIEF DESCRIPTION OF THE DRAWING FIGURES

The appended claims set forth the features of the invention with particularity. The present invention is illustrated by way of example, and not by way of limitation, in the figures of the accompanying drawings in which like reference numerals refer to similar elements.

FIG. 1 is an isometric view of a jack pad attached to a jack foot, according to embodiments described herein.

FIG. 2 is a top plan view of the base shown in FIG. 1, according to embodiments described herein.

FIG. 3 is a bottom plan view of the base with channels, according to embodiments described herein.

FIG. 4 is an isometric view of a spring clip suitable for use to secure a jack foot, according to embodiments described herein.

FIG. 5 is an isometric view of a hard stop suitable for use to secure a spring clip and a jack foot according to embodiments described herein.

FIG. 6 is a cross-sectional side view diagram through the center of a jack pad, according to embodiments described herein.

FIG. 7 shows an example configuration in which jack pad contact a jack foot at a position near an edge of the jack foot, according to embodiments described herein.

FIG. 8 is an enlarged cross-sectional view of, according to embodiments described herein.

FIG. 9 is an isometric view of an alternative jack pad attached to a jack foot, according to embodiments described herein.

FIG. 10 is a top plan view of an alternative jack pad with movable hard stops and straps, according to embodiments described herein.

FIG. 11 is a diagram of an RV 1002 with stabilizing jacks, suitable for application of the embodiments described herein.

FIG. 12 is a process flow diagram of attaching a jack pad to a jack foot, according to embodiments described herein

### DETAILED DESCRIPTION

FIG. 1 is an isometric view of a jack pad 10 attached to a jack foot 14. In some implementations, the jack foot is attached to a piston 16 that extends from a jack cylinder that is attached to a frame of an RV (not shown). The jack foot 14 is shown as perpendicular to the piston 16, as is common with hydraulic leveling jacks, although this is not required. The jack foot may extend from a rotating arm, a scissor, or any other suitable mechanism to extend and withdraw the jack foot and that is attached to a suitable part of the RV which may be a frame, a body part, or other structure of the RV. The jack foot is shown as a metal disk, but may be any other suitable shape for the particular RV.

The jack pad 10 has a base 12. The jack foot 14 is over a top surface 24 of the base 12. A spring clip 20 is attached to the base 12 at a first end and is pressed against a top surface 18 of the jack foot 14 at the opposite second end. The spring clip 20 is attached to and held in place by a hard stop 22 that is attached to the base 12 at one end and extends over the jack foot 14 at another end. In the illustrated example, four spring clips 20 and four hard stops 22 are shown placed equidistant, or 90 degrees apart, around the perimeter of the jack foot 14. More or fewer spring clips and hard stops may be used to suit particular implementations. The jack foot 14 is shown as being circular or disk-shaped, as is commonly used, however, the jack pad may be adapted to fit square, rectangular, triangular, or other shapes. The jack pad is shown as being circular but may be square, rectangular, triangular, or other shapes to suit a particular jack foot or a particular RV implementation.

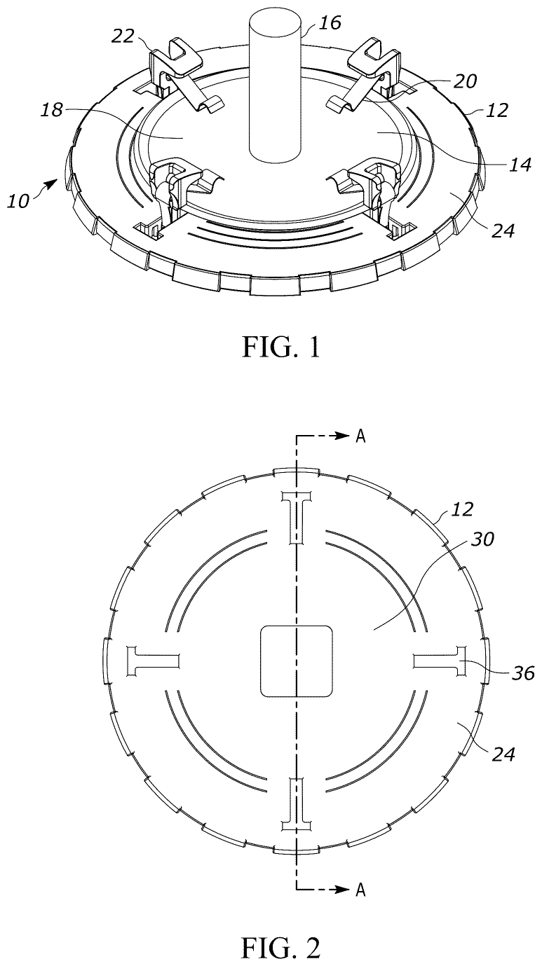

FIG. 2 is a top plan view of the base 12 shown in FIG. 1. The base is generally circular as viewed from the top with a top surface 24 and a central crown 30 of the top surface 24. The crown is circular with a diameter that is less than the diameter of the base. The width of the circumferential rim around the crown may be adapted to suit the size of the expected jack foot and to work well with the intended surface of the ground that the jack pad will rest upon when in use. One feature of the jack pad is that the diameter of the base is greater than the diameter of the jack foot so that the weight of the RV is spread over a larger area and so that the jack pad is less likely to fall into any weak parts on the surface of the ground, such as holes, sand fill, mud puddles, etc. The base includes four channels 36 spaced equidistantly around the crown 30. The channels are configured to each receive a hard stop (not shown) through a wide part that forms a primary opening at the top or bottom of the channel or both. A hard stop may be pushed through the channel from the primary opening to one or more slots (not shown).

The top surface 24 of the base 12 is shown as having marking around much of the perimeter of the crown 30. The markings are shown in the form of two concentric arcs surrounding the crown. The markings may be used as an index or guide line to line up the hard stops 22 so that all of the hard stops 22 are in the same slot of the respective channel. In this example, the hard stops may be lined up with the inner marking, the outer marking, or past the outer marking. The markings may be a part of a mold, machined into the surface, applied as a sticker or decal or made in any other suitable way.

The central crown, the circumferential rim of the top surface and the rest of the base 12 may all be formed of a single piece, i.e., they may be integral with each other. The crown may be formed integral with the base and the circumferential rim as a part of the base. All of the components may be molded or cast with the channels and slots being a part of the molding. Alternatively, the base may be machined as one or more pieces. In some versions, the crown may be formed independent of the base and attached to the base in a later operation. The base may be molded of a plastic, metal, or epoxy material and be reinforced with nylon, glass, carbon, or other types of fibers.

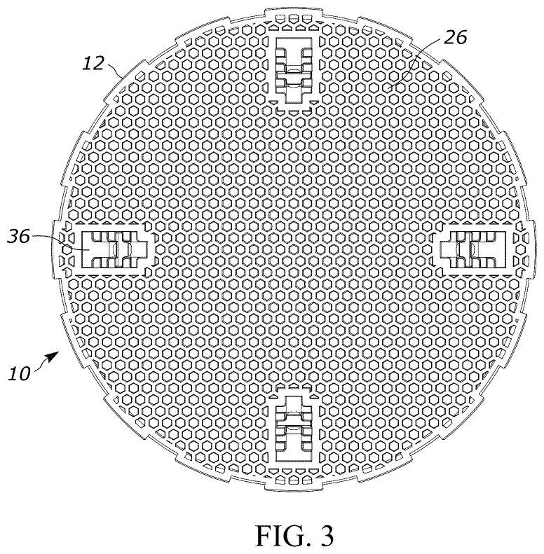

FIG. 3 is a bottom plan view of the base 12 with the channels 36 open through a bottom surface 26. The bottom surface is shown as having a hexagonal pattern of columns for strength and reduced weight, however, other patterns may be used. The bottom surface, as shown, may be molded or cast as a single part with the rest of the base including the channels 36. The bottom surface may be patterned with a texture to resist lateral movement across the ground, e.g., treads, grooves, teeth etc. The bottom surface may be covered with a material that is well-suited for resting on the ground.

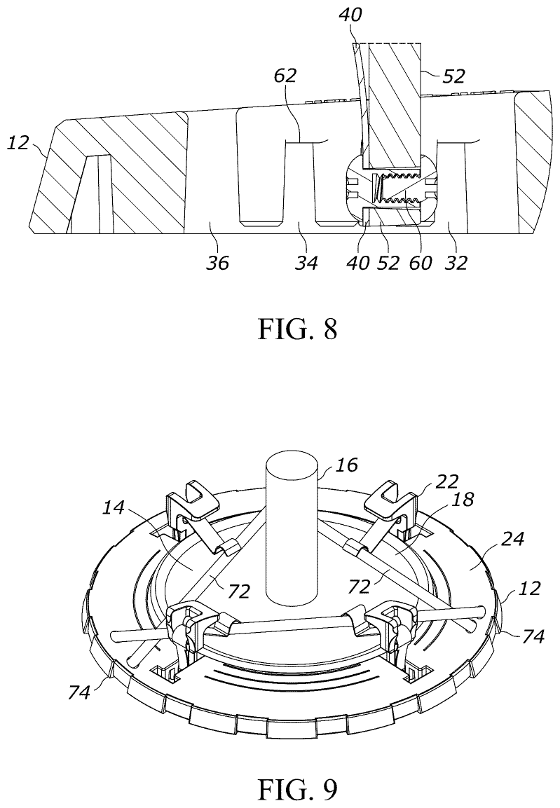

The bottom surface, and the base 12 as a whole, may have characteristics such as water resistance, drainage, light weight, temperature resistance, etc. The jack pads may be exposed to wet weather, wet ground surfaces, and water cleaning. As shown, the channels extend through the jack pad from the top to the bottom. This is shown more clearly in the enlarged cross-section of FIG. 8. The channels are not only slots through which a hard stop may be moved and attached to various slots, the channels also allow liquid on the top surface of the jack pad to flow through to the bottom surface and away from the jack pad. The curve of the crown directs water away from the jack foot and to the outer rim of the jack pad to drain. The channels are open at the bottom to allow water to flow through the channels and to prevent any water from accumulating in a channel. These two features help to aid drainage and eliminate water pockets that might develop.

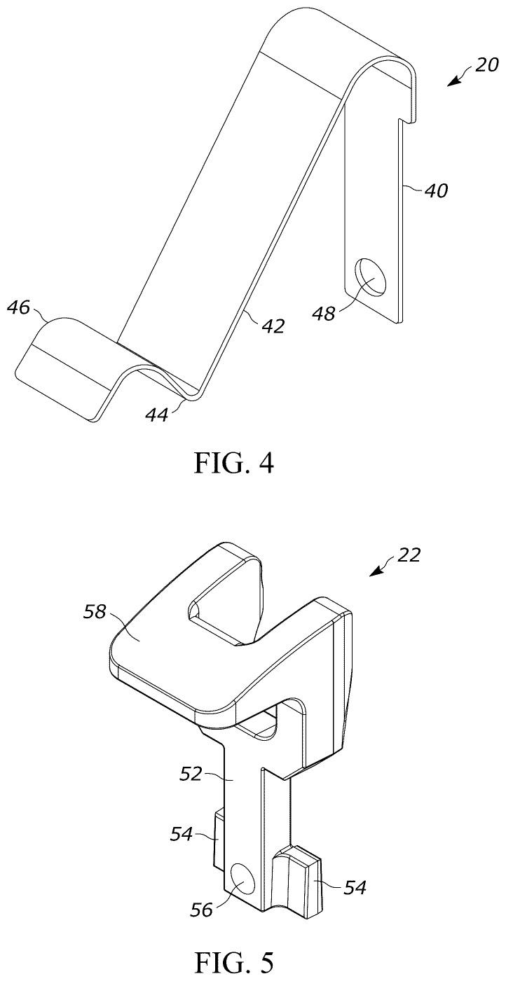

FIG. 4 is an isometric view of a spring clip 20 suitable for use to secure the jack foot 14 against the base 12. The spring clip is configured to press against a jack foot that has been received on the crown of a jack pad. The spring clip is formed from a single sheet of spring steel but may be formed of multiple parts and different materials. The spring clip has a vertical post 40 coupled to a leaf spring 42. The leaf spring is attached to a pressure plate 44 at the second end of the leaf spring. When the post at the first end is attached to the base, then the leaf spring presses the pressure plate against the top of the jack foot. The spring clip has a handle 46 at an end opposite the vertical post 40 to allow the pressure plate 44 to be manually lifted away from the top of the jack foot. This allows a jack foot to be moved between the crown of the base and the pressure plate of the spring clip. An attachment point 48 allows the spring clip to be attached to the base with a suitable fastener. In this example, the attachment point is in the form of a bolt hole 48.

While the spring clip is shown as a single piece including an attachment point 48, leaf spring, 42, pressure plate 44, and handle 46, the spring clip may be fabricated as multiple pieces. The attachment point may take different forms including tabs, clamps, and plates. The leaf spring may be formed separately or may instead be a torsion bar, coil spring, or other type of pressure device. The pressure plate may also take different forms and may present a different surface against the jack foot.

FIG. 5 is an isometric view of a hard stop 22. The hard stop may be cast or molded as a single piece of metal, such as aluminum, or a plastic, such as polycarbonate. The hard stop may alternatively be machined or formed from one or more pieces. The hard stop has a vertical post 52 that may be inserted into the base 12 as shown in FIG. 1. When attached, the vertical post extends up and away from the base 12 vertically. The vertical posts are mounted to the base using the channels 36 that are positioned around the periphery of the base. The hard stop has two tabs 54 extending from opposite sides of the post 52 in opposite directions. The tabs may be inserted into a channel of the base and then moved into a position to engage vertical slots on either side of the channel to hold the hard stop into position and to restrict lateral movement and radial movement of the hard stop. When multiple hard stops are attached to the base at an outer edge of the crown, then the posts restrict lateral movement of the jack foot across the crown.

The hard stop 22 also features an arm 58 attached to the top of the post and configured to extend from the post over the crown to restrict vertical movement of a jack foot away from the crown. The hard stops are configured to be attached to the base equidistant around the perimeter of the crown with the arms facing radially toward the center of the base and the center of the crown. The arms are, accordingly, facing each other when mounted to the base as shown in FIG. 1. The arms extending over the crown prevent the jack foot from moving from the base past the arms.

The hard stop includes an attachment point 56 on the post 52. The attachment point 56 of the post 52 is configured to be aligned with the attachment point 48 of the vertical post 40 of the spring clip 20. The hard stop 22 and the spring clip 20 may be placed against each other with the posts aligned and the leaf spring 42 passing from behind the hard stop post under the arm 58 so that the pressure plate 44 extends toward the crown 30. The spring clip 20 when fastened to the hard stop 22 is attached to the base 12 through the hard stop by the tabs 54 being engaged in slots of the base.

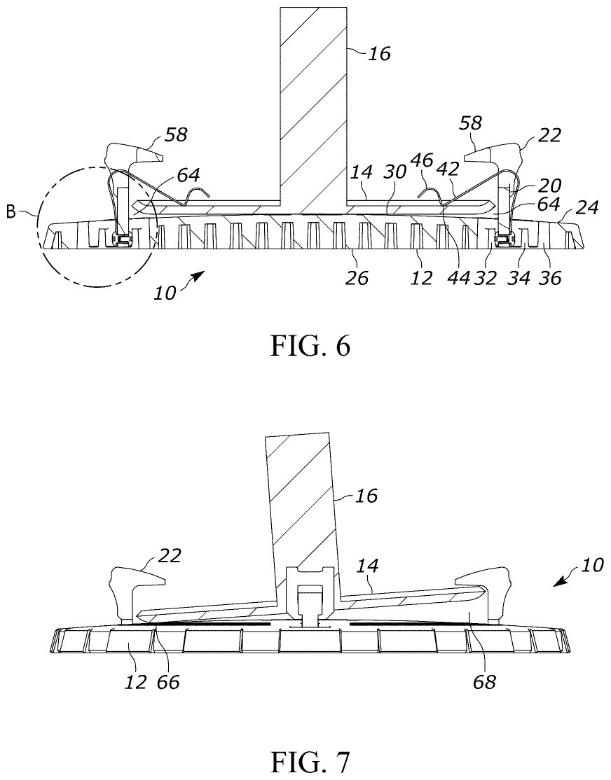

FIG. 6 is a cross-sectional side view diagram through the center of a jack pad 10 with a jack foot 14 received in the central crown 30. In this example, the jack foot 14 is attached to a jack piston 16 to raise and lower the jack foot, although other mechanisms may be supported by the jack pad. A spring clip 20 is attached to the base 12 on either side of the jack foot and the central crown. The pressure plate 44 of each spring clip is pressed against the jack foot by the respective leaf spring 42 of the spring clip. Each spring clip 20 is attached to a respective hard stop 22 using a fastener 60, such as a bolt, rivet, screw or adhesive. The hard stops are attached to the base on either side of the central crown, such that the respective spring clip is attached to the base through the hard stop.

As shown more clearly in the enlarged view of FIG. 8, the base 12 has a channel 36 that extends vertically through the base so that a hard stop, in particular the vertical post and tabs, may be passed through the base and moved along the channel to come to a slot 32, 34 in the base 12. As shown, the hard stop is placed within one slot and there is an empty slot 32, 34 on either side of the one slot that holds the hard stop. The tabs 54 of the hard stop slide into a slot on either side of the vertical post to prevent lateral and radial movement of the vertical post. The vertical movement of the post is limited by the top 62 of the slot that blocks the tabs from upward movement past the top of the respective slot. While the removable hard stops with tabs provide a simple, convenient, and stable connection to the base through the slots in the base, other configurations may be used. The hard stops may be fastened to the base in other ways using screws, bolts, or other devices. Alternatively, the hard stops may be machined or molded integrally with the base.

The channel 36 is open at the top and bottom allowing the hard stop to be inserted and removed through the channel. The multiple slots allow the hard stop to be placed in any one of the three positions that are provided by the three slots and which correspond to different radial distances from the center of the central crown. The hard stops may be placed different distances from the center to allow one jack pad to be attached to jack feet of three different diameters. The channel allows a hard stop to easily be attached to a base or removed from the base without any tools. With the hard stops 20 fixed to the base 12, the vertical posts 52 of the hard stop restrict lateral movement of the jack foot. As shown, the jack foot 14 is received at the center of the base 12 between the vertical posts 52 of the two hard stops 22. However, the jack foot 14 may not move to the left or the right very far without striking a vertical post to the left or to the right. As shown in FIG. 1, with four hard stops, the jack foot is restricted in all lateral directions.

The jack foot 14 is also vertically restricted by the hard stops 22. The hard stops 22 have an arm 58. The arms extend from a respective post over the crown to restrict vertical movement of the jack foot away from the crown. As shown, the top surface of the jack foot comes against the bottom of the arm if it is moved vertically. This allows the jack piston 16 to lift the jack foot from the ground. As the jack foot is lifted it will come against the spring clips. If the force of a spring clip is overcome, the corresponding arm will still hold the jack pad 10 to the jack foot which is attached to the jack piston.

The central crown 30 of the base 12 has an arched top surface. The crown is curved as a portion of a sphere. In this embodiment, the crown is integral with the base and the entire top surface of the base is curved as a portion of a sphere, however, this is not required. The crown may be curved while the outer perimeter 24 of the base is flat and either higher or lower than the crown. The top surface of the base is higher at the center from where the jack piston 16 extends than it is near the hard stops 22. This aids water flow away from the center and towards the outer periphery. As compared to a dished center, there will be little or no water collected under the jack foot. As shown, the center of the jack foot is in physical contact with the crown. However, the edges of the jack foot are not in physical contact with the central crown and there is a gap 64 between the jack foot and the crown at the perimeter of the jack foot and near the hard stops. In this position, the gap 64 is the same on each side. This corresponds to a peripheral gap around the whole of the jack foot. A vertical line may be drawn through the center of the piston 16 which is perpendicular to the bottom surface of the jack pad. In this example, the RV, jack, and ground are all level at the same plane, so the peripheral gap represents the position of the jack foot received by the jack pad when supporting or lifting a part of the RV. The crown 30 is curved to engage the jack foot 14 at the center of the crown directly below the center of the piston 16.

FIG. 7 shows an example configuration in which the left side of the base 12 is pushed upward against the jack foot 14 near the perimeter of the base to contact the jack foot at a position 66 near the outer edge of the jack foot. The upward movement of the left side of the base forces the right side of the base away from the jack foot due to the curve of the top surface of the base so that there is a gap 68 between the jack foot 14 and the jack pad base 12 at the crown.

The base of the jack pad may be tilted such that the left side or the right side of the jack foot is in contact with the crown. The curve of the crown 30 is configured to allow the crown to engage the jack foot 14 at different angles with respect to a vertical line from the jack foot. This vertical line is perpendicular to the bottom of the jack pad 12 and vertical with respect to the sides of the drawing sheet. The resilience of the spring clips allows the base to move with respect to the jack foot. As shown, the jack foot 14 and the piston 16 are at an angle with respect to a perpendicular and vertical line of the jack pad. In effect, the base may be rolled around the surface of the jack foot from the center of the jack foot to any edge of the jack foot. Any part of the base can move vertically to the extent allowed by the hard stop arms. The base cannot move in any direction laterally except as allowed by the vertical posts of the hard stops. This movement allows the jack pad to accommodate differences in the slope of the ground or unevenness of the ground without causing the jack foot to move.

As mentioned, the jack pad may be attached to a jack foot by first attaching one, or as many as three, of the spring clips to the base. This may be done by sliding the tabs of a hard stop and attached spring clip through a channel of the base so that the tabs are engaged in a respective slot in the base. The jack foot may be moved between each spring clip and the central crown of the base by lifting each spring clip up, or away from the base, using the handle and then moving the jack foot under the spring clip. The fourth hard stop may be attached to the base after the jack foot is installed under the first three hard stops and then the fourth spring clip may be pulled up and over the jack foot as the fourth hard stop slides into position through the fourth channel and up into the slots of the base that will hold the hard stop in position.

FIG. 9 is an isometric view of a jack pad 10 attached to a jack foot 14 that is attached to a piston 16. Alternatively, as in the other examples, the jack foot may be attached to an arm, scissor, screw or other mechanism. The jack pad 10 has a base 12. The jack foot 14 is over a top surface 24 of the base 12. A spring clip 20 is attached to the base 12 at one end and is pressed against a top surface 18 of the jack foot 14 at the opposite end. The spring clip 20 is attached to and held in place by a hard stop 22 that is attached to the base 12 at one end and extends over the jack foot 14 at another end. Various modifications and adaptations may be made to this structure, as described above.

The jack pad also has multiple elastic straps 72 attached to the base 12 at anchor points 74. Three elastic straps are shown spaced equidistant around the jack pad. The elastic straps attach at anchors that are 120 degrees apart around the circumference of the jack pad. Each strap extends across the crown of the jack pad and across the foot to the closest anchor 120 degrees away. In this way, the three straps each extend over a different part of the jack foot and do not overlap. The straps may be pulled across the jack foot, after the jack foot is placed on the base when the jack pad is attached to the jack foot. While three straps are shown, two, four, or another number of straps may be used. The elastic straps may be made of an elastomer or any other suitable material. In one implementation, the straps may be made of a vinyl or other non-elastic material and then tightened against the jack foot using a suitable coupler, buckle, clamp, ratchet, or other device (not shown). The straps are configured to hold the jack foot against the crown and may be used instead of the spring clips or the hard stops or both.

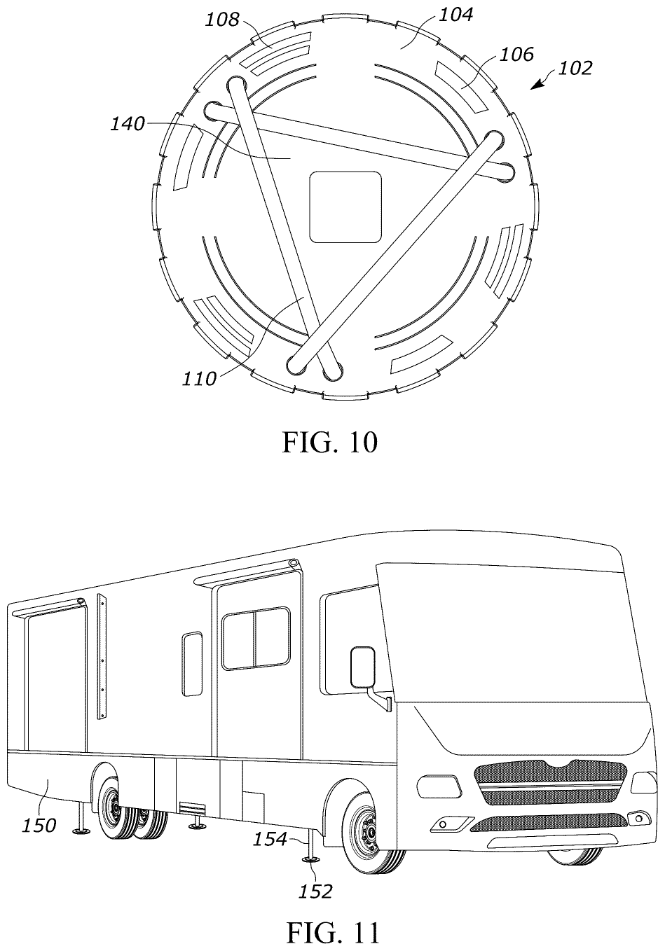

FIG. 10 is a top plan view of an alternative jack pad with straps and no movable hard stops. The jack pad 102 has a circular shape with a top surface 104 that surrounds a central crown 140. As in all the examples described herein, other shapes may be used to suit different jack feet and different RV configurations. An array of slots 106 surround the crown 140. The slots are configured to receive a hard stop 108. The hard stops may be placed in different slots to accommodate different diameters of jack feet. The hard stops have a structure of a vertical post to prevent lateral movement of the jack foot. A jack foot may not move to the left or the right, i.e., laterally, very far without striking a vertical post to the left or to the right. With three or four hard stops, the jack foot is restricted in all lateral directions.

By placing the hard stops 108 into different slots, a single jack pad may be configured for different exterior jack foot circumferences. The hard stops 108 prevent the jack foot from moving laterally past a hard stop and the straps prevent the jack foot from moving vertically.

FIG. 11 is a diagram of an RV 150 with stabilizing jacks that have a piston 154 and a jack foot for each piston 154. A jack pad 152 is attached to each jack foot at the end of the piston 154. There may be two, three, four, or more stabilizing jacks. The jacks may have also have controllers, regulators, power supplies, motors, pumps, and other components to suit particular implementations. As shown, there are four stabilizing jacks spaced near four corners of the RV. The RV and the jack positions are provided as examples of a possible use for the jack pad as described herein. The jack pad may be used for other types of vehicles and for other positions on this and other types of vehicles. The nature of the RV or trailer and its intended cargo may change and the number and positions of the stabilizer jacks may also be changed. In addition the principles described herein may also be applied to other types of jacks and to leveling jacks in particular.

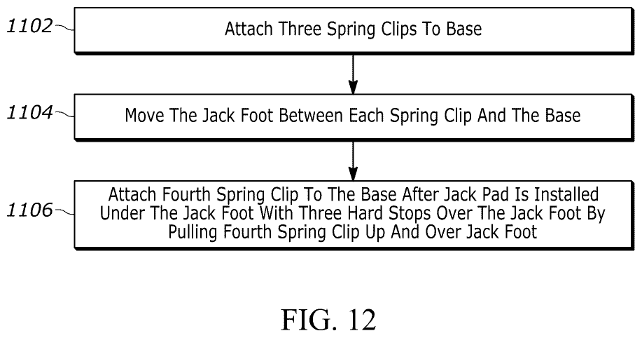

FIG. 12 is a process flow diagram of attaching a jack pad to a jack foot. The process starts after the jack foot is moved to an accessible position by extending or lowering or some other action depending on the configuration of the jack. In the process at 1102, one or more spring clips are attached to the base. In the illustrated example, three spring clips may be attached to the base by sliding tabs of each respective hard stop with its attached spring clip through a respective channel of the base so that the tabs are engaged in a respective slot in the base. The three spring clips may be attached one at a time leaving the fourth slot empty.

At 1104, the jack pad is moved under the jack foot by lifting each attached spring clip away from the base and then over the jack foot. The base of the jack pad may be moved laterally under the jack foot as each attached spring clip is lifted up to provide clearance to move the base so that the base is under the spring clip and the. The hard stop is over the jack foot for each spring clip. The spring clips may be moved one spring clip at a time. This operation can also be described in terms of the movement of the jack foot relative to the jack pad when moving the jack pad. The jack foot is moved between each attached spring clip and the base of the jack pad by lifting each spring clip away from the base and then sliding the jack pad to move the jack foot under the respective spring clip.

At 1106 the fourth spring clip is attached to the base after the jack pad is installed under the jack foot with the three spring clips over the jack foot. The fourth spring clip is installed by pulling the fourth spring clip up and over the jack foot. The fourth spring clip may be attached to the base using a hard stop as shown herein. The hard stop may first be moved into a slot so that the tabs of the hard stop are in the slot. Then the leaf spring may be moved over the jack foot. The fourth hard stop may be adjusted by pushing or pulling the hard stop down, while the leaf spring is over the jack foot and then moving the arms to an appropriate one of the slots as determined by the diameter of the jack foot.

When more or fewer hard stops and spring clips are used then more or fewer hard stops may be attached at 1102. In addition more than one hard stop may be attached at 1106. In other examples, e.g., as shown in FIG. 9, the process is completed by then pulling each of the elastic straps over the jack foot. Before this, the elastic straps may be fastened to the base and then pulled around to the underside of the base until after the last hard stop is attached. The elastic straps may then easily be pulled around the base and over the jack foot.

In another example, e.g., as shown in FIG. 10, the jack pad may be attached by moving the hack pad under the jack foot and then pulling the elastic straps over the jack foot. The hard stops may be inserted into the appropriate slots to correspond to the diameter of the jack foot after the jack pad is strapped to the jack foot. Alternatively, the hard stops may be inserted into the appropriate slots first and then the elastic straps moved into position. This may allow the hard stops to be fastened to the slots more easily, depending upon the fastening mechanism used for the slots.

While the present description is provided in the context of a circular or disk-shaped jack pad with four hard stops and spring clips, the geometry may be modified to suit different jack feet. In embodiments, the jack pad may be used with leveling jacks, stabilizing jacks or other RV accessories that use a foot that rests on the ground.

A lesser or more equipped base, spring clip, hard stop, and fastener than the examples described above may be desirable for certain implementations. Therefore, the configuration of the system will vary from implementation to implementation depending upon numerous factors, such as price constraints, performance requirements, technological improvements, and/or other circumstances.

The present description presents the examples using terms, such as jack foot, jack pad, jack piston, hard stop, and spring clip, etc. These terms are used to provide consistent, clear examples, however, the present invention is not limited to any particular terminology. Similar ideas, principles, methods, apparatus, and systems can be developed using different terminology in whole, or in part. In addition, the present invention can be applied to ideas, principles, methods, apparatus, and systems that are developed around different usage models and hardware configurations.

In the present description, for the purposes of explanation, numerous specific details are set forth in order to provide a thorough understanding of the present invention. However, the present invention can be practiced without some of these specific details. In other instances, well-known structures and devices are shown in block diagram form. The specific detail can be supplied by one of average skill in the art as appropriate for any particular implementation.

Although this disclosure describes illustrative embodiments of the invention in detail, it is to be understood that the invention is not limited to the precise embodiments described. The specification and drawings are, accordingly, to be regarded in an illustrative rather than a restrictive sense. Various adaptations, modifications and alterations may be practiced within the scope of the invention defined by the appended claims.

In an example, a jack pad comprises a base having a bottom surface configured to rest on the ground and a top surface having a crown, the crown being configured to receive a jack foot; and a plurality of spring clips, each having a first end attached to the base and a second end configured to press against the jack foot over the jack foot when the jack foot is received in the crown.

In further embodiments the spring clip comprises a handle formed at the second end.

In further embodiments the handle comprises an arc of the spring clip extending away from the crown over the crown.

In further embodiments the spring clip is formed of spring steel.

In further embodiments the spring clip includes a leaf spring to press the spring clip against the jack foot.

In further embodiments the crown is formed integral with the base.

In further embodiments the crown is curved.

In further embodiments the crown is curved as a portion of a sphere.

In further embodiments the curve of the crown is configured to allow the crown to engage the jack foot at different angles with respect to a vertical line from the jack foot.

Embodiments further include a plurality of hard stops attached to the base, each hard stop comprising a post extending away from the base.

In further embodiments the posts extend away from the base at an outer edge of the crown to restrict lateral movement of a jack foot across the crown.

In further embodiments each hard stop comprises a tab attached to the respective post, and the base comprises a plurality of slots each configured to receive a respective tab, and the slots restrict lateral movement of the respective tab across the base.

In further embodiments the base comprises a plurality of secondary slots each configured to receive a respective tab wherein the secondary slots are farther from the center of the base than the primary slots.

Embodiments further include a plurality of channels through the base to each engage a respective tab to allow the tab to travel through the channel to be removed from a respective slot and removed from the base.

In further embodiments each hard stop comprises an arm extending from a respective post over the crown to restrict vertical movement of a jack foot away from the crown.

In further embodiments the spring clip first ends are each attached to a respective hard stop and wherein the first ends are attached to the base through the respective hard stop.

Embodiments further include a plurality of elastic straps anchored to the base and extending across the crown, the elastic straps configured to hold the base to the jack foot.

In another example a jack pad comprises a base having a bottom surface configured to rest on the ground and a top surface having a crown, the crown being configured to receive a jack foot; and a plurality of hard stops attached to the base, each hard stop comprising a post extending away from the base configured to restrict lateral movement of the jack foot.

Embodiments further include a plurality of elastic straps anchored to the base and extending across the crown, the elastic straps configured to hold the base to the jack foot.

In another example a method of attaching a jack pad to a jack foot comprises attaching three spring clips to a base by sliding tabs of a respective hard stop and attached spring clip through a respective channel of the base so that the tabs are engaged in a respective slot in the base; moving the jack pad under the jack foot by lifting each attached spring clip away from the base and then over the jack foot; and attaching a fourth spring clip to the base after the jack pad is installed under the jack foot with the three hard stops over the jack foot by pulling the fourth spring clip up and over the jack foot.

What is claimed is:

1. A jack pad comprising:
a base having a bottom surface configured to rest on the ground and a top surface having a crown, the crown being configured to receive a jack foot; and
a plurality of spring clips, each having a first end attached to the base and a second end configured to press against the jack foot over the jack foot when the jack foot is received in the crown.

2. The jack pad of claim 1, wherein the spring clip comprises a handle formed at the second end.

3. The jack pad of claim 2, wherein the handle comprises an arc of the spring clip extending away from the crown over the crown.

4. The jack pad of claim 1, wherein the spring clip is formed of spring steel.

5. The jack pad of claim 4, wherein the spring clip includes a leaf spring to press the spring clip against the jack foot.

6. The jack pad of claim 1, wherein the crown is formed integral with the base.

7. The jack pad of claim 1, wherein the crown is curved.

8. The jack pad of claim 1, wherein the crown is curved as a portion of a sphere.

9. The jack pad of claim 6, wherein the curve of the crown is configured to allow the crown to engage the jack foot at different angles with respect to a vertical line from the jack foot.

10. The jack pad of claim 1, further comprising a plurality of hard stops attached to the base, each hard stop comprising a post extending away from the base.

11. The jack pad of claim 10, wherein the posts extend away from the base at an outer edge of the crown to restrict lateral movement of a jack foot across the crown.

12. The jack pad of claim 10, wherein each hard stop comprises a tab attached to the respective post, wherein the base comprises a plurality of slots each configured to receive a respective tab, and wherein the slots restrict lateral movement of the respective tab across the base.

13. The jack pad of claim 12, wherein the base comprises a plurality of secondary slots each configured to receive a respective tab wherein the secondary slots are farther from the center of the base than the primary slots.

14. The jack pad of claim 12, further comprising a plurality of channels through the base to each engage a respective tab to allow the tab to travel through the channel to be removed from a respective slot and removed from the base.

15. The jack pad of claim 10, wherein each hard stop comprises an arm extending from a respective post over the crown to restrict vertical movement of a jack foot away from the crown.

16. The jack pad of claim 10, wherein the spring clip first ends are each attached to a respective hard stop and wherein the first ends are attached to the base through the respective hard stop.

17. The jack pad of claim 1, further comprising a plurality of elastic straps anchored to the base and extending across the crown, the elastic straps configured to hold the base to the jack foot.

18. A jack pad comprising:
a base having a bottom surface configured to rest on the ground and a top surface having a crown, the crown being configured to receive a jack foot; and
a plurality of hard stops attached to the base, each hard stop comprising a post extending away from the base configured to restrict lateral movement of the jack foot.

19. The jack pad of claim 18, further comprising a plurality of elastic straps anchored to the base and extending across the crown, the elastic straps configured to hold the base to the jack foot.

20. A method of attaching a jack pad to a jack foot, the method comprising:
attaching three spring clips to a base by sliding tabs of a respective hard stop and attached spring clip through a respective channel of the base so that the tabs are engaged in a respective slot in the base;
moving the jack pad under the jack foot by lifting each attached spring clip away from the base and then over the jack foot; and
attaching a fourth spring clip to the base after the jack pad is installed under the jack foot with the three hard stops over the jack foot by pulling the fourth spring clip up and over the jack foot.
